(19) United States
(12) Patent Application Publication
(10) Pub. No.: US 2015/0346402 A1
(43) Pub. Date: Dec. 3, 2015

(54) NEAR-INFRARED RADIATION ABSORBING MASTERBATCH, NEAR-INFRARED RADIATION ABSORBING PRODUCT MADE FROM THE MASTERBATCH, AND METHOD OF MAKING NEAR-INFRARED RADIATION ABSORBING FIBER FROM THE MASTERBATCH

(71) Applicant: TAIFLEX SCIENTIFIC CO ., LTD., Kaohsiung (TW)

(72) Inventors: Yu-Chih Kao, Kaohsiung (TW); Chi-Yung Chang, Kaohsiung (TW); Kuan-Yu Li, Kaohsiung (TW); Tzu-Ching Hung, Kaohsiung (TW)

(21) Appl. No.: 14/452,704

(22) Filed: Aug. 6, 2014

(30) Foreign Application Priority Data
May 30, 2014 (TW) 103118968

(51) Int. Cl. G02B 5/20; G02B 1/04; D01D 5/08; G02B 5/22

(52) U.S. Cl. CPC G02B 5/208; G02B 5/22; G02B 1/04; D01D 5/08; D10B 2401/00

(57) ABSTRACT

The near-infrared radiation absorbing masterbatch provided is prepared by melt-extruding a mixture comprising near-infrared radiation absorbing particles and a first polymer. The particles have a near-infrared absorption at a wavelength ranging from 0.7 μm to 2 μm and a far-infrared emissivity equal to or more than 0.85. The near-infrared light radiated by the particles has a wavelength ranging from 2 μm to 22 μm. Accordingly, the product made from the masterbatch, such as the near-infrared radiation absorbing fiber, plate, or film can not only absorb sunlight and store heat, but also radiate far-infrared light. Hence, the product has a thermal effect for keeping the human body warm and can serve as indoor and outdoor heat storing products at the same time.

### BACKGROUND OF THE INVENTION

1. Field of the Invention

The present invention relates to a near-infrared radiation absorbing masterbatch; especially relates to a near-infrared radiation absorbing masterbatch, which not only can absorb sunlight and store heat, but also can radiate far-infrared light. The present invention also relates to a near-infrared radiation absorbing product made from the masterbatch and a method of making a near-infrared radiation absorbing fiber from the masterbatch.

2. Description of the Prior Arts

Far-infrared light radiating materials are added into fibers to keep the warmness and comfort of clothes.

As patent publication No. GB2303375 A discloses, ZrO₂, ZrSiO₄, SiO₂, and TiO₂ are taken as far-infrared light radiating materials. As patent publication No. CN1558007 A discloses, bamboo charcoal is taken as a far-infrared light radiating material. Although the fibers comprising far-infrared light radiating materials can radiate far-infrared light, the fibers have poor heat absorption, such that the clothes made of the fibers have to adhere tightly to the human body to absorb the heat of the human body and radiate far-infrared light for the human body to absorb. Therefore, the thermal effect of the fibers comprising far-infrared light radiating materials is limited for keeping the human body warm.

In view of the above, how to absorb heat effectively is researched in textile industry, and the near-infrared radiation absorbing materials are developed as a solution. As patent publication No. JPH01132816 A discloses, ZrC, Sb₂O₃, and SnO₂ are taken as near-infrared radiation absorbing materials to absorb the near-infrared light of sunlight. Although the fibers comprising near-infrared radiation absorbing materials absorb the near-infrared light of sunlight and store heat, the fibers have poor far-infrared light radiation; especially, the fibers cannot absorb sunlight and store heat in an indoor environment. Hence, the thermal effect of the fibers comprising near-infrared radiation absorbing materials is limited for keeping the human body warm.

As such, the conventional technique fails to provide a near-infrared radiation absorbing material which not only can effectively absorb sunlight and store heat, but also can radiate far-infrared light and be applied on both indoor and outdoor heat storing products.

To overcome the shortcomings, the present invention provides a near-infrared radiation absorbing masterbatch, a near-infrared radiation absorbing product made from the masterbatch, and a method of making a near-infrared radiation absorbing fiber from the masterbatch to mitigate or obviate the aforementioned problems.

### SUMMARY OF THE INVENTION

The main objective of the present invention is to provide a near-infrared radiation absorbing masterbatch which not only can absorb sunlight and store heat, but also can radiate far-infrared light, and can be applied on indoor and outdoor heat storing products.

To achieve the aforementioned objective, the near-infrared radiation absorbing masterbatch provided by the present invention is prepared by melt-extruding a mixture comprising near-infrared radiation absorbing particles and a first polymer. The particles have a near-infrared absorption at a wavelength ranging from 0.7 micrometers (μm) to 2 μm and a far-infrared emissivity equal to or more than 0.85. The near-infrared light that the particles radiate has a wavelength ranging from 2 μm to 22 μm.

Preferably, the particles are selected from the group consisting of:

(a) antimony doped tin oxide;

(b) fluorine doped tin oxide;

(c) titanium dioxide coated with antimony doped tin oxide;

(d) titanium dioxide coated with fluorine doped tin oxide;

(e) titanium dioxide coated with antimony doped tin oxide and fluorine doped tin oxide; and

(f) a combination of at least two of (a), (b), (c), (d), and (e).

Preferably, the concentration of the particles ranges from 5 weight percent (wt %) to 40 wt % based on the weight of the near-infrared radiation absorbing masterbatch.

Preferably, the first polymer is selected from the group consisting of: polyamide, polypropylene, polyethylene, polyester, and any combination thereof.

More preferably, the first polymer is polyamide 6 or polyethylene terephthalate.

Preferably, the particles have a secondary particle size ranging from 10 nanometers (nm) to 1 μm.

The present invention also provides a near-infrared radiation absorbing product made from the near-infrared radiation absorbing masterbatch mentioned above and a second polymer.

Preferably, the near-infrared radiation absorbing product is a near-infrared radiation absorbing plate, a near-infrared radiation absorbing film, or a near-infrared radiation absorbing fiber.

Preferably, the second polymer is selected from the group consisting of: polyamide, polypropylene, polyethylene, polyester, and any combination thereof.

In the near-infrared radiation absorbing product in accordance with the present invention, the near-infrared radiation absorbing fiber has a cross section being perpendicular to a longitudinal axis of the near-infrared radiation absorbing fiber. The cross section of the near-infrared radiation absorbing fiber is circular, quadrangular, X-shaped, or Y-shaped.

Preferably, the near-infrared radiation absorbing fiber is a hollow-core fiber; specifically, the near-infrared radiation absorbing fiber has a hollow core.

Preferably, the near-infrared radiation absorbing fiber is a sheath-core fiber; specifically, the cross section of the near-infrared radiation absorbing fiber has a core layer and a sheath layer surrounding the core layer.

More preferably, the core layer is consisted of the near-infrared radiation absorbing masterbatch, the sheath layer is consisted of the second polymer, and the near-infrared radiation absorbing particles are dispersed in the core layer.

More preferably, the core layer is consisted of the second polymer, the sheath layer is consisted of the near-infrared radiation absorbing masterbatch, and the near-infrared radiation absorbing particles are dispersed in the sheath layer.

The present invention also provides a method of making a near-infrared radiation absorbing fiber from the near-infrared radiation absorbing masterbatch mentioned above; the method comprises steps of:

blending the near-infrared radiation absorbing masterbatch and the second polymer mentioned above to obtain a blend; and

melt spinning the blend to obtain the near-infrared radiation absorbing fiber; wherein

a concentration of the near-infrared radiation absorbing particles in the near-infrared radiation absorbing fiber ranges from 0.1 wt % to 5 wt % based on the weight of the near-infrared radiation absorbing fiber.

Based on the above, by the particles having a near-infrared absorption at a wavelength ranging from 0.7 μm to 2 μm and a far-infrared emissivity at a wavelength ranging from 2 μm to 22 μm equal to or more than 0.85, the product made from the masterbatch in accordance with the present invention, such as the near-infrared radiation absorbing fiber and a fabric made of the fiber, not only can absorb sunlight and store heat, but also can radiate far-infrared light. Hence, the product made from the masterbatch in accordance with the present invention has a thermal effect for keeping human body warm and can serve as indoor and outdoor heat storing products at the same time.

Other objectives, advantages and novel features of the invention will become more apparent from the following detailed description when taken in conjunction with the accompanying drawings.

### BRIEF DESCRIPTION OF THE DRAWINGS

FIG. 1 shows a cross section of the near-infrared radiation absorbing fiber of Example 1, wherein the cross section is perpendicular to the longitudinal axis of the near-infrared radiation absorbing fiber;

FIG. 2 shows a cross section of the near-infrared radiation absorbing fiber of Example 9, wherein the cross section is perpendicular to the longitudinal axis of the near-infrared radiation absorbing fiber;

FIG. 3 shows a cross section of the near-infrared radiation absorbing fiber of Example 10, wherein the cross section is perpendicular to the longitudinal axis of the near-infrared radiation absorbing fiber;

FIG. 4 shows a cross section of the near-infrared radiation absorbing fiber of Example 11, wherein the cross section is perpendicular to the longitudinal axis of the near-infrared radiation absorbing fiber;

FIG. 5 shows a cross section of the near-infrared radiation absorbing fiber of Example 12, wherein the cross section is perpendicular to the longitudinal axis of the near-infrared radiation absorbing fiber;

FIG. 6 shows a cross section of the near-infrared radiation absorbing fiber of Example 13, wherein the cross section is perpendicular to the longitudinal axis of the near-infrared radiation absorbing fiber;

FIG. 7 shows a cross section of the near-infrared radiation absorbing fiber of Example 14, wherein the cross section is perpendicular to the longitudinal axis of the near-infrared radiation absorbing fiber; and

FIG. 8 shows ultraviolet-visible-near-infrared (UV-Vis-NIR) spectra of near-infrared radiation absorbing particles of Example 1 and Comparison example 2.

### DETAILED DESCRIPTION OF THE PREFERRED EMBODIMENTS

### Example 1

### Fabrication of Near-Infrared Radiation Absorbing Masterbatch, Fiber, and Fabric

<Fabrication of Near-Infrared Radiation Absorbing Masterbatch>

Near-infrared radiation absorbing particles, a dispersion agent, and a first polymer were mixed evenly by a hansel mixer to obtain a mixture. The mixture was melted and extruded at 220° C. to 250° C. by a twin screw extruder. Then a near-infrared radiation absorbing masterbatch was obtained. The weight ratio of the near-infrared radiation absorbing particles, the dispersion agent, and the first polymer was 1:0.1:8.9. The concentration of the near-infrared radiation absorbing particles in the near-infrared radiation absorbing masterbatch was 10 wt % based on the weight of the near-infrared radiation absorbing masterbatch.

In the present example, the particles were antimony doped tin oxide (ATO) purchased from Inframat Advanced Materials Co., Ltd. The atomic ratio of antimony to tin was 1:9. The secondary particle size of the particles was between 40 nm and 100 nm. The particles had a near-infrared absorption at a wavelength ranging from 0.7 μm to 2 μm. Also, the particles had a far-infrared emissivity of 0.94. The far-infrared light radiated by the particles had a wavelength ranging from 2 μm to 22 μm. Besides, the dispersion agent was 3-aminopropyltriethoxysilane (APTES) purchased from Sigma-Aldrich Co. and the first polymer was polyamide 6 resin purchased from Li Peng Enterprise Co., Ltd.

<Fabrication of Near-Infrared Radiation Absorbing Fiber>

The near-infrared radiation absorbing masterbatch and a second polymer were blended at a weight ratio of 1:9 and a blend was obtained. The blend was extruded at 240° C. and filaments were obtained. The filaments were winded by a winding machine with a winding rate of 3500 meters/minutes (m/min) to prepare a 110d/48f partially oriented yarn. The “110d/48f” meant that the partially oriented yarn was 110 denier (d) in weight and was consisted of 48 filaments (f). Then, the 110d/48f partially oriented yarn was false twist textured by a friction-twist draw-texturing machine and a 70d/48f near-infrared radiation absorbing fiber. The “70d/48f” meant that the near-infrared radiation absorbing fiber was 70 denier (d) in weight and was consisted of 48 filaments (f).

In the present example, the second polymer was polyamide 6 resin. The concentration of the near-infrared radiation absorbing particles in the near-infrared radiation absorbing fiber was 1 wt % based on the weight of the near-infrared radiation absorbing fiber.

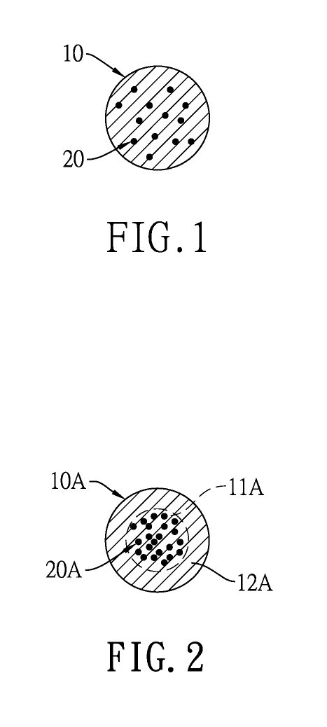

FIG. 1 showed a cross section of the near-infrared radiation absorbing fiber 10. The cross section was perpendicular to the longitudinal axis of the near-infrared radiation absorbing fiber 10. The cross section was circular and the near-infrared radiation absorbing particles 20 were dispersed in the near-infrared radiation absorbing fiber.

<Fabrication of Near-Infrared Radiation Absorbing Fabric>

The near-infrared radiation absorbing fiber was weaved by a loom and a near-infrared radiation absorbing fabric was obtained.

### Example 2

### Fabrication of Near-Infrared Radiation Absorbing Masterbatch, Fiber, and Fabric

The present example was similar to Example 1. The differences between the present example and Example 1 were as follows.

In fabrication of the near-infrared radiation absorbing masterbatch: The weight ratio of the near-infrared radiation absorbing particles, the dispersion agent, and the first polymer was 1:0.1:18.9. The concentration of the near-infrared radiation absorbing particles in the near-infrared radiation absorbing masterbatch was 5 wt % based on the weight of the near-infrared radiation absorbing masterbatch.

In fabrication of near-infrared radiation absorbing fiber: The weight ratio of the near-infrared radiation absorbing masterbatch and the second polymer was 1:4. The concentration of the near-infrared radiation absorbing particles in the near-infrared radiation absorbing fiber was 1 wt % based on the weight of the near-infrared radiation absorbing fiber.

### Example 3

### Fabrication of Near-Infrared Radiation Absorbing Masterbatch, Fiber, and Fabric

The present example was similar to Example 1. The differences between the present example and Example 1 were as follows.

In fabrication of the near-infrared radiation absorbing masterbatch: The weight ratio of near-infrared radiation absorbing particles, the dispersion agent, and the first polymer was 4:0.4:5.6. The concentration of the near-infrared radiation absorbing particles in the near-infrared radiation absorbing masterbatch was 40 wt % based on the weight of the near-infrared radiation absorbing masterbatch.

In fabrication of the near-infrared radiation absorbing fiber: The weight ratio of the near-infrared radiation absorbing masterbatch and the second polymer was 1:39. The concentration of the near-infrared radiation absorbing particles in the near-infrared radiation absorbing fiber was 1 wt % based on the weight of the near-infrared radiation absorbing fiber.

### Example 4

### Fabrication of Near-Infrared Radiation Absorbing Masterbatch, Fiber, and Fabric

The present example was similar to Example 1. The differences between the present example and Example 1 were as follows.

In fabrication of the near-infrared radiation absorbing fiber: The weight ratio of the near-infrared radiation absorbing masterbatch and the second polymer was 1:190. The concentration of near-infrared radiation absorbing particles in the near-infrared radiation absorbing fiber was 0.1 wt % based on the weight of the near-infrared radiation absorbing fiber.

### Example 5

### Fabrication of Near-Infrared Radiation Absorbing Masterbatch, Fiber, and Fabric

The present example was similar to Example 1. The differences between the present example and Example 1 were as follows.

In fabrication of the near-infrared radiation absorbing fiber: The weight ratio of the near-infrared radiation absorbing masterbatch and the second polymer was 1:1. The concentration of the near-infrared radiation absorbing particles in the near-infrared radiation absorbing fiber was 5 wt % based on the weight of the near-infrared radiation absorbing fiber.

### Example 6

### Fabrication of Near-Infrared Radiation Absorbing Masterbatch, Fiber, and Fabric

The present example was similar to Example 1. The differences between the present example and Example 1 were as follows.

In fabrication of the near-infrared radiation absorbing masterbatch: The near-infrared radiation absorbing particles were titanium dioxide coated with antimony doped tin oxide (TiO₂ coated with ATO) purchased from Ishihara Sangyo Kaisha, Ltd. The secondary particle size of the particles was between 800 nm and 900 nm. The particles had a near-infrared absorption at a wavelength ranging from 0.7 μm to 2 μm. Also, the particles had a far-infrared emissivity of 0.87. The far-infrared light radiated by the particles had a wavelength ranging from 2 μm to 22 μm.

### Example 7

### Fabrication of Near-Infrared Radiation Absorbing Masterbatch, Fiber, and Fabric

The present example was similar to Example 1. The differences between the present example and Example 1 were as follows.

In fabrication of the near-infrared radiation absorbing masterbatch: The mixture which comprised near-infrared radiation absorbing particles, the dispersion agent, and the first polymer was melt and extruded at 250° C. to 280° C. by the twin screw extruder to obtain the near-infrared radiation absorbing masterbatch. The first polymer was polyethylene terephthalate resin purchased from Far Eastern New Century Co.

In fabrication of the near-infrared radiation absorbing fiber: The second polymer was polyethylene terephthalate resin. The blend was extruded at 285° C. to obtain the filaments. The filaments were winded by the winding machine at a winding rate of 3200 m/min to prepare a 125d/72f partially oriented yarn. Then, the 125d/72f partially oriented yarn was false twist textured by the friction-twist draw-texturing machine to obtain a 75d/72f near-infrared radiation absorbing fiber.

### Example 8

### Fabrication of Near-Infrared Radiation Absorbing Masterbatch, Fiber, and Fabric

The present example was similar to Example 7. The differences between the present example and Example 7 were as follows.

In fabrication of the near-infrared radiation absorbing masterbatch: The near-infrared radiation absorbing particles were fluorine doped tin oxide (FTO) purchased from Keeling and Walker, Ltd. The secondary particle size of the particles was between 100 nm and 150 nm. The particles had a near-infrared absorption at a wavelength ranging from 0.7 μm to 2 μm. Also, the particles had a far-infrared emissivity of 0.92. The far-infrared light radiated by antimony doped tin oxide particles had a wavelength ranging from 2 μm to 22 μm.

### Example 9

### Near-Infrared Radiation Absorbing Fiber

The near-infrared radiation absorbing fiber of the present example was similar to Example 1. The differences between the present example and Example 1 were as follows.

With reference to FIG. 2, the cross section being perpendicular to the longitudinal axis of the near-infrared radiation absorbing fiber 1 OA had a core layer 11A and a sheath layer 12A surrounding the core layer 11A; specifically, the near-infrared radiation absorbing fiber 10A was a sheath-core fiber. The core layer 11A was consisted of the near-infrared radiation absorbing masterbatch and the sheath layer 12A was consisted of the second polymer. Besides, the near-infrared radiation absorbing particles 20A were dispersed in the core layer 11A and were located at the center of the cross section.

### Example 10

### Near-Infrared Radiation Absorbing Fiber

The near-infrared radiation absorbing fiber of the present example was similar to Example 9. The differences between the present example and Example 9 were as follows.

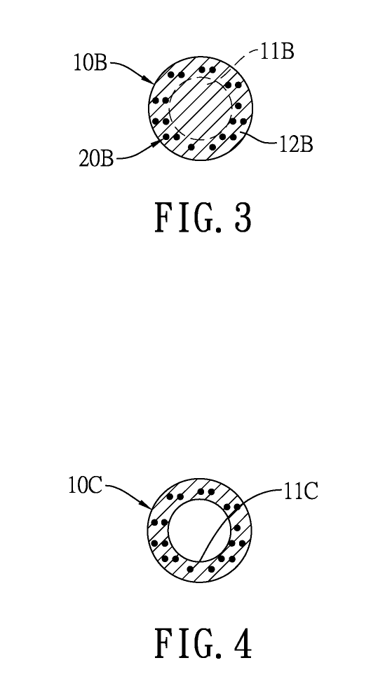

With reference to FIG. 3, The core layer 11B of the cross section of the near-infrared radiation absorbing fiber 10B was consisted of the second polymer. The sheath layer 12B of the near-infrared radiation absorbing fiber 10B was consisted of the near-infrared radiation absorbing masterbatch. Also, the near-infrared radiation absorbing particles 20B were dispersed in the sheath layer 12B and were close to the edge of the cross section.

### Example 11

### Near-Infrared Radiation Absorbing Fiber

The near-infrared radiation absorbing fiber of the present example was similar to Example 1. The differences between the present example and Example 1 were as follows.

With reference to FIG. 4, the cross section being perpendicular to the longitudinal axis of the near-infrared radiation absorbing fiber 10C had a hollow core 11C at the center; specifically, the near-infrared radiation absorbing fiber 10C was a hollow-core fiber 10C.

### Example 12

### Near-Infrared Radiation Absorbing Fiber

The near-infrared radiation absorbing fiber of the present example was similar to Example 1. The differences between the present example and Example 1 were as follows.

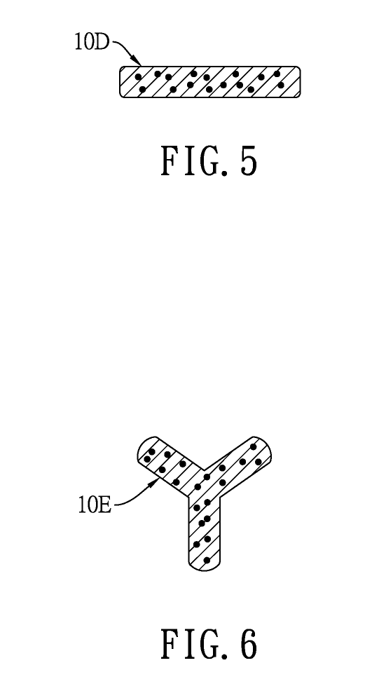

With reference to FIG. 5, the cross section being perpendicular to the longitudinal axis of the near-infrared radiation absorbing fiber 10D was quadrangular; specifically, the cross section was rectangular.

### Example 13

### Near-Infrared Radiation Absorbing Fiber

The near-infrared radiation absorbing fiber of the present example was similar to Example 1. The differences between the present example and Example 1 were as follows.

With reference to FIG. 6, the cross section being perpendicular to the longitudinal axis of the near-infrared radiation absorbing fiber 10E was Y-shaped.

### Example 14

### Near-Infrared Radiation Absorbing Fiber

The near-infrared radiation absorbing fiber of the present example was similar to Example 1. The differences between the present example and Example 1 were as follows.

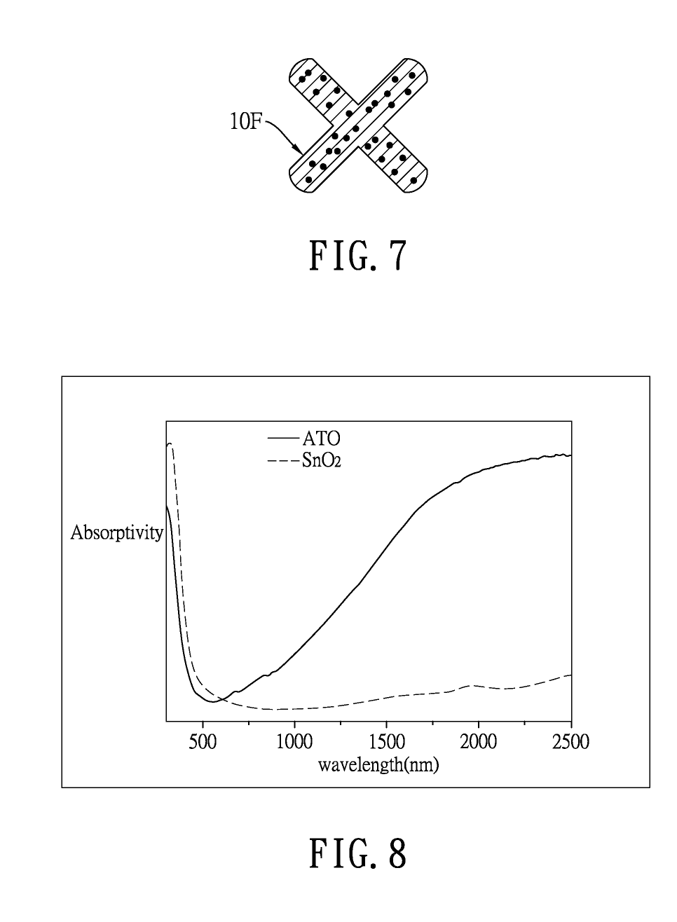

With reference to FIG. 7, the cross section being perpendicular to the longitudinal axis of the near-infrared radiation absorbing fiber 1 OF was X-shaped.

### Comparison Example 1

### Fabrication of Near-Infrared Radiation Absorption Masterbatch, Fiber, and Fabric

The present comparison example was similar to Example 1. The differences between the present comparison example and Example 1 were as follows.

In fabrication of the near-infrared radiation absorbing masterbatch: The near-infrared radiation absorbing particles were zirconium carbide (ZrC) purchased from John Young Enterprise Co., Ltd. The secondary particle size of the particles was between 800 nm and 950 nm. The particles had a near-infrared absorption at a wavelength ranging from 1.2 μm to 2 μm. Also, the particles had the far-infrared emissivity of 0.86.

### Comparison Example 2

### Fabrication of Near-Infrared Radiation Absorbing Masterbatch, Fiber, and Fabric

The present comparison example was similar to Example 1. The differences between the present comparison example and Example 1 were as follows.

In fabrication of the near-infrared radiation absorbing masterbatch: The near-infrared radiation absorbing particles were tin dioxide (SnO₂) purchased from John Young Enterprise Co., Ltd. The secondary particle size of the particles was between 300 nm and 500 nm. The particles had a near-infrared absorption at a wavelength ranging from 1.2 μm to 2 μm. Also, the particles had the far-infrared emissivity of 0.86.

### Comparison Example 3

### Fabrication of Near-Infrared Radiation Absorbing Masterbatch, Fiber, and Fabric

The present comparison example was similar to Example 1. The differences between the present comparison example and Example 1 were as follows.

In fabrication of the near-infrared radiation absorbing masterbatch: The near-infrared radiation absorbing particles were zirconium dioxide (ZrO₂) purchased from Sigma-Aldrich Co. The secondary particle size of the particles was between 800 nm and 900 nm. The particles had no near-infrared absorption at a wavelength ranging from 0.7 μm to 2 μm. Also, the particles had the far-infrared emissivity of 0.93.

### Comparison Example 4

### Fabrication of Far-Infrared Radiation Emitting Masterbatch, Fiber, and Fabric

The present comparison example was similar to Example 1. In the present comparison example, far-infrared radiation emitting particles were used to fabricate the far-infrared radiation emitting masterbatch, fiber and fabric. The difference between the present comparison example and Example 1 was that the far-infrared radiation emitting particles were used in the comparison example to substitute the near-infrared radiation absorbing particles as used in Example 1.

In fabrication of far-infrared radiation emitting masterbatch of the present comparison example: the far-infrared radiation emitting particles were porphyritic andesite purchased from John Young Enterprise Co., Ltd. The secondary particle size of the particles was between 800 nm and 1000 nm. The particles had no near-infrared absorption at a wavelength ranging from 0.7 μm to 2 μm. Also, the particles had the far-infrared emissivity of 0.91.

### Comparison Example 5

### Fabrication of Near-Infrared Radiation Absorbing Masterbatch, Fiber, and Fabric

The present comparison example was similar to Example 7. The difference between the present comparison example and Example 7 was as follows.

In fabrication of the near-infrared radiation absorbing masterbatch: The near-infrared radiation absorbing particles were zirconium carbide (ZrC) used in Comparison example 1.

### Comparison Example 6

### Fabrication of Far-Infrared Radiation Absorbing Masterbatch, Fiber, and Fabric

The present comparison example was similar to Example 7. In the present comparison example, far-infrared radiation emitting particles were used to fabricate the far-infrared radiation emitting masterbatch, fiber and fabric. The difference between the present comparison example and Example 7 was that the far-infrared radiation emitting particles were used in the comparison example to substitute the near-infrared radiation absorbing particles as used in Example 7.

In fabrication of the far-infrared radiation emitting masterbatch of the present comparison example: Far-infrared ray radiation emitting particles used were bamboo charcoal purchased from Jiangshan Luyi Bamboo Charcoal Co., Ltd. The secondary particle size of the particles was between 300 nm and 400 nm. The particles had no near-infrared absorption at a wavelength ranging from 0.7 μm to 2 μm. Also, the particles had the far-infrared emissivity of 0.93.

### Comparison Example 7

### Fabrication of Far Infrared Radiation Emitting Masterbatch, Fiber, and Fabric

The present comparison example was similar to Example 7. In the present comparison example, far-infrared radiation emitting particles were used to fabricate the far-infrared radiation emitting masterbatch, fiber and fabric. The difference between the present comparison example and Example 7 was that the far-infrared radiation emitting particles were used in the comparison example to substitute the near-infrared radiation absorbing particles as used in Example 7.

In fabrication of the far-infrared radiation emitting masterbatch of the present comparison example: The far-infrared radiation emitting particles used were aluminum oxide (Al₂O₃) purchased from Sigma-Aldrich Co. The secondary particle size of the particles was between 800 nm and 900 nm. The particles had no near-infrared absorption at a wavelength ranging from 0.7 μm to 2 μm. Also, the particles had the far-infrared emissivity of 0.94.

### Test Example 1

### Temperature Rise Property

A halogen lamp had a power of 500 watts was placed above a fabric. The perpendicular distance between the halogen lamp and the surface of the fabric was 100 centimeters (cm). The angle between the light of the halogen lamp and the surface of the fabric was 45°. After the surface of the fabric was radiated by the light of the halogen lamp, a thermo tracer purchased from NEC Co. measured the surface temperature of the fabric.

The temperature rise property was measured by the temperature difference between the surface temperatures of a testing fabric and a standard fabric. The temperature difference was represented by the symbol, ΔT₁. A testing fabric with high ΔT₁ had good temperature rise property. Compared with a testing fabric having poor temperature rise property, a testing fabric having good temperature rise property was more suitable for inner clothing.

When the testing fabric was the near-infrared radiation absorbing fabric of Examples 1 to 6, the near-infrared radiation absorbing fabric of Comparison examples 1 to 3, or the far-infrared radiation emitting fabric of Comparison example 4, the standard fabric was a pure polyimide 6 resin fabric. When the testing fabric was the near-infrared radiation absorbing fabric of Examples land 8, the near-infrared radiation absorbing fabric of Comparison example 5, or the far-infrared radiation emitting fabric of Comparison examples 6 and 7, the standard fabric was a pure polyethylene terephthalate fabric.

The testing results of the present test example were shown in Tables 1 to 6.

### Test Example 2

### Solar Heat Gain Property

The fabrics of each example and each comparison example were located 12 meters away from the solar simulator purchased from All Real Technology Co. Ltd. The model of the solar simulator was APOLLO. The light of the solar simulator radiated the surface of the fabrics with an energy of 500 watts/meter square (W/m²) for 10 minutes. The surface temperatures of the fabrics before and after radiated by the light of the solar simulator were measured by a thermo tracer.

The solar heat gain property was measured by the temperature difference (ΔT₂) between the surface temperatures of a fabric before and after radiated by the light of the solar simulator. A fabric with high ΔT₂ had good solar heat gain property.

In addition, whether a fabric could store heat and keep the human body warm efficiently at outdoors or not depended on ΔT₂. A fabric with high ΔT₂ indicated that the fabric could efficiently store heat and keep the human body warm at outdoors. Hence, a fabric that had good solar heat gain property also could efficiently store heat and keep human body warm at outdoors.

The testing results of the present test example were shown in Tables 1 to 6.

### Test Example 3

### Far-Infrared Emissivity

The far-infrared emissivity of the fabrics of each example and each comparison example were measured at 25° C. by the far-infrared spectrometer purchased from Bruker Co. The model number of the far-infrared spectrometer was VERTEX70. The testing results of the present test example were shown in Tables 1 to 6. The far-infrared radiation had a wavelength ranging from 2 μm to 22 μm.

### Test Example 4

### Ultraviolet-Visible-Near-Infrared (UV-Vis-NIR) Spectrum

The near-infrared radiation absorbing particles of Example 1 and potassium bromide (KBr) were mixed and grinded in an agate mortar to obtain a fine powder. The fine powder was compressed to be a specimen by tablet machine. The absorption spectroscopy of the specimen at waveband ranging from 300 nm to 2000 nm was measured by an UV-Vis-NIR spectrophotometer purchased from Hitachi. The model number of the UV-Vis-NIR spectrophotometer was U-4100. The absorption spectroscopy of the specimen was the absorption spectroscopy of the near-infrared radiation absorbing particles of Example 1.

An absorption spectroscopy of the near-infrared radiation absorbing particles of Comparison example 2 was measured and obtained by the same method as the absorption spectroscopy of the near-infrared radiation absorbing particles of Example 1.

The testing results of the present test example were shown in FIG. 8.

TABLE 1
the species of the near-infrared radiation absorbing particles,
the concentration of the near-infrared radiation absorbing particles in the
near-infrared radiation absorbing masterbatch, the concentration of the
near-infrared radiation absorbing particles in the near-infrared radiation
absorbing fiber, and ΔT₁, ΔT₂, and far-infrared emissivity of
the near-infrared radiation absorbing fabric of each of Examples 1 to 3.

| | Example No. | | | | | |
|---|---|---|---|---|---|---|
| | 1 | | 2 | | 3 | |
| Species of near-infrared | ATO | | ATO | | ATO | |
| radiation absorbing particles | | | | | | |
| Concentration of | 10 | wt % | 5 | wt % | 40 | wt % |
| near-infrared radiation | | | | | | |
| absorbing particles in | | | | | | |
| near-infrared radiation | | | | | | |
| absorbing masterbatch | | | | | | |
| Concentration of | 1 | wt % | 1 | wt % | 1 | wt % |
| near-infrared radiation | | | | | | |
| absorbing particles in | | | | | | |
| near-infrared radiation | | | | | | |
| absorbing fiber | | | | | | |
| ΔT₁ | 5.6° | C. | 5.6° | C. | 5.6° | C. |
| ΔT₂ | 15.3° | C. | 15.3° | C. | 15.3° | C. |

| | | | |
|---|---|---|---|
| Far-infrared emissivity | 0.83 | 0.83 | 0.83 |

As demonstrated from Table 1, the species of the near-infrared radiation absorbing particles of Examples 1 to 3 were antimony doped tin oxide (ATO). The near-infrared radiation absorbing fibers and fabrics had the same concentration of near-infrared radiation absorbing particles; the fibers and fabrics, which were made from the near-infrared radiation absorbing masterbatches having different concentrations of near-infrared radiation absorbing particles, had equivalent ΔT₁, ΔT₂, and far-infrared emissivity. That was, the near-infrared radiation absorbing fibers and fabrics of Examples 1 to 3 had equivalent temperature rise property, solar heat gain property, and far-infrared emissivity.

TABLE 2
the species of the near-infrared radiation absorbing particles,
the concentration of the near-infrared radiation absorbing particles in the
near-infrared radiation absorbing masterbatch, the concentration of the
near-infrared radiation absorbing particles in the near-infrared radiation
absorbing fiber, and ΔT₁, ΔT₂, and far-infrared emissivity of the
near-infrared radiation absorbing fabric of each of Examples 1, 4, and 5.

| | Example No. | | | | | |
|---|---|---|---|---|---|---|
| | 1 | | 4 | | 5 | |
| Species of near-infrared | ATO | | ATO | | ATO | |
| radiation absorbing particles | | | | | | |
| Concentration of | 10 | wt % | 10 | wt % | 10 | wt % |
| near-infrared radiation | | | | | | |
| absorbing particles in | | | | | | |
| near-infrared radiation | | | | | | |
| absorbing masterbatch | | | | | | |
| Concentration of | 1 | wt % | 0.1 | wt % | 5 | wt % |
| near-infrared radiation | | | | | | |
| absorbing particles in | | | | | | |
| near-infrared radiation | | | | | | |
| absorbing fiber | | | | | | |
| ΔT₁ | 5.6° | C. | 0.7° | C. | 8.3° | C. |
| ΔT₂ | 15.3° | C. | 2.2° | C. | 18.7° | C. |

| | | | |
|---|---|---|---|
| Far-infrared emissivity | 0.83 | 0.80 | 0.83 |

As demonstrated from Table 2, the species of the near-infrared radiation absorbing particles of Examples 1, 4, and 5 were antimony doped tin oxide. The results shown in Table 2 proved that as the concentration of near-infrared radiation absorbing particles in a near-infrared radiation absorbing fiber increased, the ΔT₁, ΔT₂, and far-infrared emissivity of a near-infrared radiation absorbing fabric made of the fiber increased. That was, temperature rise property, solar heat gain property, and far-infrared emissivity of a near-infrared radiation absorbing fabric increased with the increasing concentration of near-infrared radiation absorbing particles in a near-infrared radiation absorbing fiber used to make the fabric.

TABLE 3
the species of the near-infrared radiation absorbing particles,
the concentration of the near-infrared radiation absorbing particles in the
near-infrared radiation absorbing fiber, and ΔT₁, ΔT₂, and far-infrared
emissivity of the near-infrared radiation absorbing fabric of each
of Examples 1, 6, and Comparison examples 1 to 3.

| | Example No. | | | | Comparison example No. | | | | | |
|---|---|---|---|---|---|---|---|---|---|---|
| | 1 | | 6 | | 1 | | 2 | | 3 | |
| Species of | ATO | | TiO₂ | | ZrC | | SnO₂ | | ZrO₂ | |
| near-infrared | | | coated | | | | | | | |
| radiation | | | with | | | | | | | |
| absorbing | | | ATO | | | | | | | |
| particles | | | | | | | | | | |
| Concentration of | 1 | wt % | 1 | wt % | 1 | wt % | 1 | wt % | 1 | wt % |
| near-infrared | | | | | | | | | | |
| radiation | | | | | | | | | | |
| absorbing | | | | | | | | | | |
| particles in | | | | | | | | | | |
| near-infrared | | | | | | | | | | |
| radiation absorbing | | | | | | | | | | |
| fiber | | | | | | | | | | |
| ΔT₁ | 5.6° | C. | 5.2° | C. | 1.6° | C. | 1.7° | C. | 1.8° | C. |
| ΔT₂ | 15.3° | C. | 14.6° | C. | 8.4° | C. | 6.3° | C. | 4.2° | C. |

| | | | | | |
|---|---|---|---|---|---|
| Far-infrared | 0.83 | 0.82 | 0.78 | 0.79 | 0.82 |
| emissivity | | | | | |

TABLE 4
the species of the far-infrared radiation emitting particles, the
concentration of the far-infrared radiation emitting particles in the
far-infrared radiation emitting fiber, and ΔT₁, ΔT₂, and far-infrared
emissivity of the far-infrared radiation emitting fabric of Comparison
example 4.

| | Comparison | |
|---|---|---|
| | example No. | |
| | 4 | |
| Species of far-infrared radiation | porphyritic andesite | |
| emitting particles | | |
| Concentration of far-infrared radiation | 1 | wt % |
| emitting particles in far-infrared | | |
| radiation emitting fiber | | |
| ΔT₁ | 2.2° | C. |
| ΔT₂ | 4.6° | C. |

| | |
|---|---|
| Far-infrared emissivity | 0.82 |

As demonstrated from Tables 3 and 4, the species of the near-infrared radiation absorbing particles of Examples 1 and 6 were antimony doped tin oxide and titanium dioxide coated with antimony doped tin oxide. By antimony doped tin oxide and titanium dioxide coated with antimony doped tin oxide, the near-infrared radiation absorbing fabrics of Examples 1 and 6 had higher ΔT₁ and ΔT₂ than the near-infrared radiation absorbing fabrics of Comparison examples 1 to 3 and the far-infrared radiation absorbing fabric of Comparison examples 1 to 4. That was, the near-infrared radiation absorbing fabrics of Examples 1 and 6 had good temperature rise property and solar heat gain property. Also, the near-infrared radiation absorbing fabrics of Examples 1 and 6 could efficiently store heat and keep the human body warm at outdoors.

In addition, as demonstrated from Tables 3 and 4, the better way to elevate the temperature of the near-infrared radiation absorbing fabrics of Comparison examples 1 and 2 was absorbing sunlight. The better way to elevate the temperature of the near-infrared radiation absorbing fabric of Comparison example 3 and the far-infrared radiation emitting fabric of Comparison example 4 was radiating far-infrared light. Both absorbing sunlight and radiating far-infrared light were good for elevating the temperature of the near-infrared radiation absorbing fabrics of Examples 1 and 6.

With reference to FIG. 8, antimony doped tin oxide, which was the near-infrared radiation absorbing particles of Example 1, had an absorption at a wavelength equal to or more than 700 nm; whereas tin oxide, which was the near-infrared radiation absorbing particles of Comparison example 2, had an absorption at a wavelength equal to or more than 1200 nm. Also, the near-infrared absorption of tin oxide at a wavelength equal to or more than 700 nm was lower than the absorptivity of antimony doped tin oxide. Hence, compared to the near-infrared radiation absorbing particles of Comparison example 2, the near-infrared radiation absorbing particles of Example 2 had an obvious absorption at a wavelength equal to or more than 700 nm.

With reference to Table 3 and FIG. 8, by the near-infrared radiation absorbing particles having an obvious absorption at a wavelength equal to or more than 700 nm, the near-infrared radiation absorbing fabric of Example 1 had a better solar heat gain property (ΔT₂) than the near-infrared radiation absorbing fabric of Comparison example 2 and could store heat and keep the human body warm at outdoors more efficiently than that of Comparison example 2.

TABLE 5
the species of the near-infrared radiation absorbing particles,
the concentration of the near-infrared radiation absorbing particles in the
near-infrared radiation absorbing fiber, and ΔT₁, ΔT₂, and far-infrared
emissivity of the near-infrared radiation absorbing fabric of each of
Examples 7, 8, and Comparison example 5.

| | | | | | Comparison | |
|---|---|---|---|---|---|---|
| | Example No. | | | | example | |
| | 7 | | 8 | | No. 5 | |
| Species of | ATO | | FTO | | ZrC | |
| near-infrared | | | | | | |
| radiation absorbing | | | | | | |
| particles | | | | | | |
| Concentration of | 1 | wt % | 1 | wt % | 1 | wt % |
| near-infrared | | | | | | |
| radiation absorbing | | | | | | |
| particles in | | | | | | |
| near-infrared | | | | | | |
| radiation absorbing fiber | | | | | | |
| ΔT₁ | 5.8° | C. | 5.5° | C. | 1.7° | C. |
| ΔT₂ | 16.3° | C. | 15.8° | C. | 8.7° | C. |

| | | | |
|---|---|---|---|
| Far-infrared | 0.83 | 0.82 | 0.78 |
| emissivity | | | |

TABLE 6
the species of the far-infrared radiation emitting particles, the
concentration of the far-infrared radiation emitting particles in the far-
infrared radiation emitting fiber, and ΔT₁, ΔT₂, and far-infrared
emissivity of the far-infrared radiation emitting fabric of each of
Comparison examples 6 and 7.

Comparison
example No.

| | 6 | | 7 | |
|---|---|---|---|---|
| Species of far-infrared | bamboo charcoal | | Al₂O₃ | |
| radiation emitting particles | | | | |
| Concentration of far- | 1 | wt % | 1 | wt % |
| infrared radiation emitting | | | | |
| particles in far-infrared | | | | |
| radiation emitting fiber | | | | |
| ΔT₁ | 2.0° | C. | 2.3° | C. |
| ΔT₂ | 5.6° | C. | 4° | C. |

| | | |
|---|---|---|
| Far-infrared emissivity | 0.82 | 0.82 |

As demonstrated from Tables 5 and 6, the species of the near-infrared radiation absorbing particles of Examples 7 and 8 were antimony doped tin oxide and fluorine doped tin oxide respectively. By antimony doped tin oxide and fluorine doped tin oxide, the near-infrared radiation absorbing fabrics of Examples 7 and 8 had higher ΔT₁ and ΔT₂ than the near-infrared radiation absorbing fabric of Comparison example 5 and the far-infrared radiation emitting fabrics of 6 and 7. That was, the near-infrared radiation absorbing fabrics of Examples 7 and 8 had good temperature rise property and solar heat gain property. Also, the near-infrared radiation absorbing fabrics of Examples 7 and 8 could efficiently store heat and keep the human body warm at outdoors.

In addition, as demonstrated from Table 4, the better way to elevate the temperature of the near-infrared radiation absorbing fabrics of Comparison example 5 was absorbing sunlight. The better way to elevate the temperature of the far-infrared radiation emitting fabrics of Comparison examples 6 and 7 was radiating far-infrared light. Both absorbing sunlight and radiating far-infrared light were good for elevating the temperature of the near-infrared radiation absorbing fabrics of Examples 7 and 8.

Based on the above, by selecting antimony doped tin oxide, titanium dioxide coated with antimony doped tin oxide and fluorine doped tin oxide as the near-infrared radiation absorbing particles, which had a near-infrared absorption and a far-infrared emissivity having a wavelength ranging from 2 μm to 22 μm equal to or more than 0.85, the near-infrared radiation absorbing fibers made from the near-infrared radiation absorbing masterbatches of Examples 1 to 8 by melt spinning were capable of being made into the near-infrared radiation absorbing fabrics having good sunlight absorptivity and far-infrared emissivity. Hence, the near-infrared radiation absorbing fibers were suitable for indoor and outdoor heat storing products at the same time.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A near-infrared radiation absorbing masterbatch, which is provided by melt-extruding a mixture comprising near-infrared radiation absorbing particles and a first polymer, wherein the particles have:
a near-infrared absorption at a wavelength ranging from 0.7 μm to 2 μm; and
a far-infrared emissivity equal to or more than 0.85 at a wavelength ranging from 2 μm to 22 μm.

2. The masterbatch as claimed in claim 1, wherein the particles are selected from the group consisting of:
(a) antimony doped tin oxide;
(b) fluorine doped tin oxide;
(c) titanium dioxide coated with antimony doped tin oxide;
(d) titanium dioxide coated with fluorine doped tin oxide;
(e) titanium dioxide coated with antimony doped tin oxide and fluorine doped tin oxide; and
(f) a combination of at least two of (a), (b), (c), (d), and (e).

3. The masterbatch as claimed in claim 1, wherein the concentration of the particles ranges from 5 wt % to 40 wt % based on the weight of the masterbatch.

4. The masterbatch as claimed in claim 1, wherein the first polymer is selected from the group consisting of: polyamide, polypropylene, polyethylene, polyester, and combinations thereof.

5. The masterbatch as claimed in claim 1, wherein the particles have a secondary particle size ranging from 10 nm to 1 μm.

6. A near-infrared radiation absorbing product, which is made from the near-infrared radiation absorbing masterbatch claimed in claim 1 and a second polymer.

7. The product as claimed in claim 6, wherein the product is a near-infrared radiation absorbing plate, a near-infrared radiation absorbing film, or a near-infrared radiation absorbing fiber.

8. The product as claimed in claim 7, wherein the near-infrared radiation absorbing fiber has a cross section being perpendicular to a longitudinal axis of the near-infrared radiation absorbing fiber and the cross section of the near-infrared radiation absorbing fiber is circular, quadrangular, X-shaped, or Y-shaped.

9. The product as claimed in claim 8, wherein the cross section of the near-infrared radiation absorbing fiber has a hollow core.

10. The product as claimed in claim 8, wherein the cross section of the near-infrared radiation absorbing fiber has
a core layer consisted of the masterbatch and having the particles dispersed in the core layer; and
a sheath layer surrounding the core layer and consisted of the second polymer.

11. The product as claimed in claim 8, wherein the cross section of the near-infrared radiation absorbing fiber has
a core layer consisted of the second polymer; and
a sheath layer surrounding the core layer, consisted of the masterbatch, and having the particles dispersed in the sheath layer.

12. The product as claimed in claim 6, wherein the second polymer is selected from the group consisting of: polyamide, polypropylene, polyethylene, polyester, and combinations thereof.

13. A method of making a near-infrared radiation absorbing fiber comprising steps of:
blending a near-infrared radiation absorbing masterbatch as claimed in claim 1 and a second polymer to obtain a blend; and
melt spinning the blend to obtain the near-infrared radiation absorbing fiber;
wherein a concentration of the particles in the near-infrared radiation absorbing fiber ranges from 0.1 wt % to 5 wt % based on the weight of the fiber.

14. The method as claimed in claim 13, wherein the second polymer is selected from the group consisting of: polyamide, polypropylene, polyethylene, polyester, and combinations thereof.
